(19) United States
(12) Patent Application Publication
(10) Pub. No.: US 2009/0163222 A1
(43) Pub. Date: Jun. 25, 2009

(54) METHOD FOR PERFORMING RESOURCE ALLOCATION IN A WIRELESS COMMUNICATION NETWORK, BASE STATION AND WIRELESS COMMUNICATION NETWORK

(75) Inventors: Joerg Schaepperle, Stuttgart (DE); Roland Munzner, Bissingen/Teck (DE)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/323,864

(22) Filed: Nov. 26, 2008

(30) Foreign Application Priority Data
Nov. 30, 2007 (EP) 07301605.7

(51) Int. Cl. H04W 72/00

(52) U.S. Cl. 455/452.2; 455/450

(57) ABSTRACT

The present invention relates to a method for performing resource allocation to a mobile terminal (12) in a wireless communication network (10), said wireless communication network (10) comprising a plurality of base stations (BS0-BS12). The method comprises the steps of measuring link quality of one or more wireless links (14) in between said mobile terminal (12) and one or more of said plurality of base stations (BS0-BS12), allocating wireless resources to said mobile terminal (12) in one or more serving sectors, said serving sectors being one or more of said plurality of sectors (SEC0.0, SEC0.1, SEC0.2, SEC0, SEC1.0, SEC1.1, SEC1, SEC2.0, SEC2.1, SEC2, SEC3-SEC12) in one or more of said plurality of cells (C0-C12). The invention further relates to a plurality of base stations for performing said method and a wireless communication network (10) comprising said plurality of base stations.

### BACKGROUND OF THE INVENTION

The invention is based on a priority application EP07301605.7 which is hereby incorporated by reference.

The present invention relates to a method of performing resource allocation to a mobile terminal in a wireless communication network, said wireless communication network comprising a plurality of base stations, each of said plurality of base stations serving a cell, each cell comprising a plurality of sectors. The invention further relates to a plurality of base stations for performing said method and to a wireless communication network comprising said plurality of base stations.

Due to the increasing popularity of wireless communication, especially high speed broadband wireless communication, wireless communication systems comprising bandwidth efficient multiple access schemes are of particular interest. Wireless systems are shared media systems. There is a fix available bandwidth which must be shared among all the users of the system. It is therefore desired that wireless, especially radio, access systems be as efficient as possible to maximize the number of users that can be served and to maximize the data rates at which the service is provided.

Typical wireless, especially radio, access networks are implemented as so called cellular systems which comprise a plurality of cells, served by base stations, which are controlled by radio network controllers. The base stations communicate over one or more wireless links with one or more mobile terminals, which are located inside the cell service area. The cell service area of a base station is the cell that is serviced by said base station. The cell may be divided into several sectors each consisting of a transceiver with a single or multiple antennas and RF chains and an area, a so called sector, typically served by that transceiver. A mobile terminal may for example be a mobile computer, a mobile phone or any mobile or even fixed device that is able to communicate wirelessly.

It is also known in the art that a cellular wireless system may experience intra cell and/or inter cell interference problems which limit the capacity of the system. The intra cell interference is the interference experienced by one user that is caused by other users communicating within the same cell. The inter cell interference is defined as the interference experienced by one user that is caused by other users communicating in cells other than the one in which the user is located. Inter cell interference is especially present at the borders of cells.

In the European Patent Application EP 1594260 A1 a method for inter cell interference coordination is presented which employs power planning in a radio communication system employing multi carrier techniques such as OFDM (Orthogonal Frequency Division Multiplex). In this method in each cell a border cell region and an inner cell region is identified. Power planning is applied to terminals which communicate from the border cell region of a cell.

In current broadband wireless access networks coverage and throughput are limited by co-channel interference. Co-channel interference can be due to intro cell interference or due to inter cell interference. In OFDM systems co-channel interference is typically caused by inter-cell interference. Coverage and throughput are especially limited by co-channel interference in radio communication networks where the full set of radio resources can potentially be allocated at all points in the wireless network area. Those networks are also known as frequency re-use 1 networks. Frequency re-use in general describes an allocation of frequency sets also called channels to cells based on a predetermined pattern. In frequency re-use 1 systems the same frequency sets or channels are assigned to all cells in the system.

### OBJECT OF THE INVENTION

The object of the invention is to increase coverage and throughput in wireless communication networks, especially in frequency re-use 1 networks. It is another object of the invention to provide a plurality of base stations in a wireless communication network providing increased coverage and throughput. It is another object of the invention to provide a wireless communication network, especially a frequency re-use 1 network, with increased coverage and throughput.

### SUMMARY OF THE INVENTION

These objects and others that appear below are achieved by a method for performing resource allocation to a mobile terminal in a wireless communication network, said wireless communication network comprising a plurality of base stations, each of said plurality of base stations serving a cell, each cell comprising a plurality of sectors; the method comprising the steps of measuring link quality of one or more wireless links in between said mobile terminal and one or more of said plurality of base stations, allocating wireless resources to said mobile terminal in one or more serving sectors, said serving sectors being one or more of said plurality of sectors in one or more of said plurality of cells.

The invention further relates to a plurality of base stations of a wireless communication network, each of said plurality of base stations serving a cell, each cell comprising a plurality of sectors, whereas each of said plurality of base stations is adapted to measure link quality of one or more wireless links to a mobile terminal and comprises means for determining one or more serving sectors, said serving sectors being one or more of said plurality of sectors in one or more of said plurality of cells, whereas resource allocation to the mobile terminal is performed in the one or more serving sectors.

According to a first aspect of the invention, coverage and throughput in a wireless communication network, especially a radio communication network, is increased by coordinating the transmissions between different base stations and different sectors of said base station. A mobile terminal communicates with one or more base stations over one or more wireless links. The wireless channel in a wireless communication network or the radio channel in a radio communication network is a resource shared in between several terminals communicating using said wireless or radio communication network. Wireless or radio resources have therefore to be allocated to mobile terminals by resource allocation modules. In OFDM systems radio resources are time slots or subcarriers in the frequency domain. In CDMA systems radio resources may also be spreading codes. Preferably, resource allocation modules serve a sector of a cell each. It is also possible, that a resource allocation module serves more than one sector of a cell, all sectors of a cell or even sectors of different cells. Coordinating the transmissions of different base stations is especially useful in areas (terminal positions) where the terminals receives signals with similar strength from different base stations or different base stations receive the signal from one terminal with similar strength. In conventional systems this is the cell edge area and the different signals interfere each other. Serving a terminal by different sectors means that the sector areas overlap. The interference is reduced and the signal quality improved by constructive superposition.

According to another aspect of the invention, the link quality of a wireless link or wireless links in between a mobile terminal and one or more base stations is measured. Depending on the outcome of this measurement wireless resources are allocated to the terminal. Wireless resources are allocated in one or more serving sectors. The serving sectors can be located in one cell or in several cells of the communication network. Among the resource allocation modules associated with the serving sectors of a terminal the allocation of radio resources must be coordinated. One solution is to determine one master resource allocation module. The master resource allocation module allocates the resources to the mobile terminal in the serving sectors. Other methods for coordination of the allocation of radio resources among the resource allocation modules associated with the serving sectors would be to make negotiations among the resource allocation modules or to make votes among the resource allocation modules. Each module can for example make proposals and the other resource allocation modules can agree or disagree. If all resource allocation modules agree or a majority of them agrees, the proposal is turned into a decision. The resource allocation module assigned to a sector is responsible for coordinating the resource allocations for different terminals in that sector. To prevent unwanted multiple allocations of the same resource, it has for example to communicate with the master resource allocation modules responsible for that allocations.

According to one embodiment of the invention, in each of the serving sectors the transmitters associated with the serving sectors transmit the same information on the same radio resources to the mobile terminal. In the serving sectors the receivers associated with the serving sectors receive information from the mobile terminal.

According to the inventive method, the number of transmitters that transmit the same information to the mobile terminal and the number of receivers that process the signals received from the mobile terminal at the base station of the serving sectors are selected in dependence of the link qualities between the mobile station and different base stations.

According to a preferred embodiment of the invention the downlink signals from different transmitters are added in the air by using RF (radio frequency) combining. This is especially advantageous for OFDM systems. The sum signal can be received with a single antenna at the terminal. By applying the invention, a performance gain is achieved by using a single antenna at the mobile terminal. No further processing at the mobile terminal is necessary to achieve the gain.

According to another preferred embodiment of the invention the uplink signals received by different receivers are combined at a master base station. A master base station may be the base station comprising said master resource allocation module. The combination of the signals received by different receivers is preferably done using signal processing.

According to another embodiment of the invention the downlink signals transmitted by the transmitters associated with the serving sectors are pre coded in such a way that they superpose advantageously at the receiver or can be processed by the receiver in such a way that a performance gain is achieved. Pre coding can e.g. be done in such a way that the different signals arriving at the receiver have the same phase on each subcarrier at every time or in such a way that based on average channel statistics the probability for constructive superposition is increased.

According to another preferred embodiment of the invention, the resource allocation module is a layer 2 module, preferably a media access control (MAC) instance. The information exchange in between different Radio Access Modules can be over layer 2 or layer 3.

According to another embodiment of the invention, the traffic requirements of the wireless links in between said mobile terminal and the base stations is measured. The allocation of the wireless resources is then done also taking into account the measured traffic requirements.

In another preferred embodiment of the invention a master resource allocation module is determined among candidate resource allocation modules. The candidate resource allocation modules are the resource allocation modules associated with the one or more serving sectors. For each radio resource (time/frequency interval) a different master resource allocation module can be determined, depending on the mapping of frequency resources to terminals. Typically one master resource allocation module is required per terminal. It coordinates the resource allocations in the resource allocation modules of all sectors that serve the terminal and allocates all resources used for said terminal.

According to another aspect of the invention the plurality of base stations in a wireless communication network are adapted to measure link quality of a wireless link or wireless links to a mobile terminal. The plurality of base stations comprise means for determining one or more serving sectors and means for determining a master resource allocation module. The serving sectors are located in the cells being served by said plurality of base stations. The serving sectors are determined according to the measured link quality to the mobile terminal. The master resource allocation module allocates wireless resources to the mobile terminal. It allocates resources of the serving sectors. The master resource allocation module is one of the resource allocation modules associated with the serving sectors.

According to a preferred embodiment of the invention the plurality of base stations is preferably comprised in a frequency re-use 1 network. The same frequency resources are therefore allocated by all the base stations in the network.

According to a preferred embodiment of the invention the resource allocation modules are layer 2 modules, preferably media access control (MAC) instances.

According to another preferred embodiment of the invention the plurality of base stations are adapted to measure traffic requirements between base stations and mobile terminal. The traffic requirements are requirements concerning the quantity of data that is to be transmitted. The traffic requirements are measured in addition to the link quality of the one or more wireless links. The decision on the serving cell sectors is then taken depending on the quality of the link and the traffic requirements.

According to another preferred embodiment of the invention, the determination of a master resource allocation module is performed by the resource allocation modules associated with the one or more serving sectors. The resource allocation modules are comprised in one ore more base stations.

According to another aspect of the invention, the wireless communication network, preferably a frequency re-use 1 radio network, offers increased coverage and throughput by coordination of the wireless transmission between different base stations and different sectors of the base station. According to a preferred embodiment of the invention the base stations are connected by logical or physical links between the base stations. A logical link might be a link via a core network. A physical link might be a direct link made of e. g. wire, fibre, wireless, radio, optical, microwaves etc.

The plurality of base stations might be of the same type. It is also possible to apply and coordinate different types of base stations, e. g. of different wireless standards.

According to another aspect of the invention coverage and throughput are optimised by selecting appropriate modes of operation. A mode of operation is characterised by the serving sectors involved in the resource allocation to the mobile terminal. The mode of operation is determined using measured link performance data and optionally traffic requirements per mobile terminal and link. Traffic requirements are for example required data rates per mobile terminal and link. The mode of operation is derived from said measured data by applying appropriate algorithms. Depending on the mobile terminals the different locations of mobile terminals and the different link qualities and data rate requirements, different modes of operation can be applied to different mobile terminals.

### BRIEF DESCRIPTION OF THE DRAWINGS

Other characteristics and advantages of the invention will become apparent in the following detailed description of preferred embodiments of the invention illustrated by the accompanying drawings given by way of non limiting illustrations. The same reference numerals may be used in different figures of the drawings to identify the same or similar elements.

FIG. 1 shows the schematic overview over a wireless communication network comprising three base stations and three cells,

FIG. 2 shows a schematic overview over a wireless communication network comprising seven cells and seven corresponding base stations,

FIG. 3 shows a schematic overview over a wireless communication network with sectors,

FIG. 4 shows a schematic overview over a wireless communication network with areas comprising sectors,

FIG. 5 shows an overview over a wireless communication network with thirteen cells and thirteen corresponding base stations with areas comprising sectors,

FIG. 6 shows an overview over a wireless communication network comprising seven cells and seven base stations with areas comprising parts of sectors of cells.

### DETAILED DESCRIPTION OF THE INVENTION

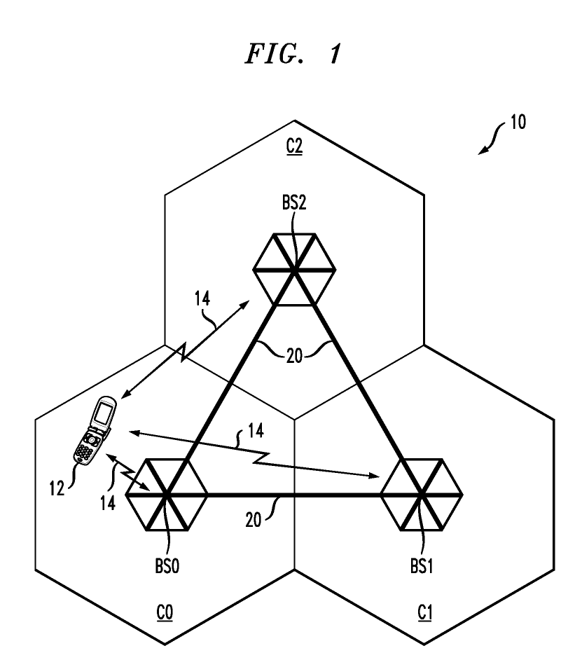

Shown in FIG. 1 is a schematic overview of a wireless telecommunication network 10 comprising three cells C0, C1 and C2 and corresponding base stations BS0, BS1 and BS2. The base stations BS0, BS1 and BS2 are connected by links 20. The links 20 can be logical or physical links between the base stations BS0, BS1 and BS2. A logical link 20 is for example a link via the core network. The physical link 20 is a direct connection between the base stations for example, wire, fibre, wireless, optical, microwave, wireless, radio etc. FIG. 1 also shows a mobile terminal 12 connected to the base stations BS0, BS1 and BS2 over wireless links 14. The links 20 between the base stations BS0, BS1, BS2 can transport useful information to be transmitted to mobile terminal 12 or to be received from mobile terminal 12. The links 20 can also transport information required for wireless resource allocation e. g. radio resource allocation either in form of real time information or signals statistics. In a preferred embodiment of the invention the links 20 are local, meaning that they are in between directly neighboured base stations.

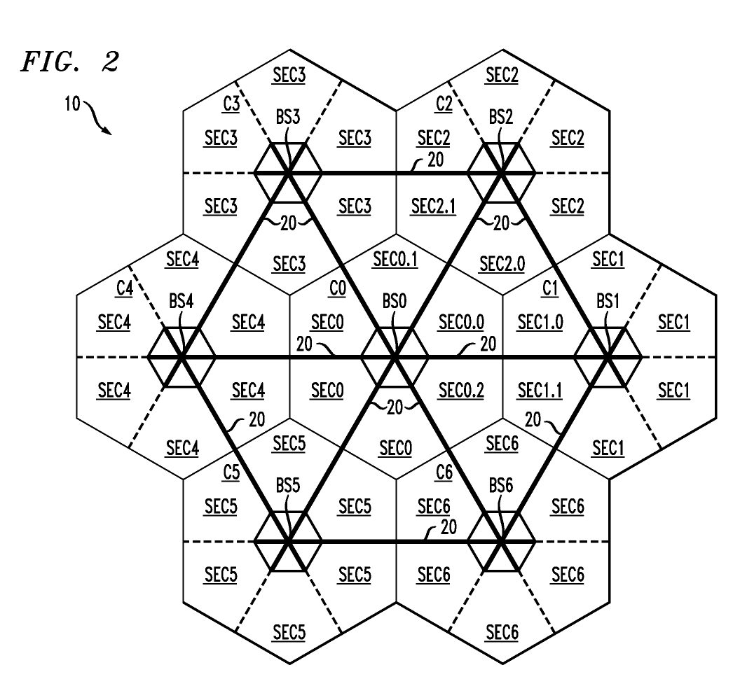

In FIG. 2 a wireless communication network is shown. The wireless communication network comprises 7 cells C0, C1, C2, C3, C4, C5 and C6 and corresponding base stations BS0, BS1, BS2, BS3, BS4, BS5 and BS6. Neighbouring base stations are connected by links 20. In the example shown in FIG. 2, each cell is divided into six sectors. Cell C0 is for example divided into sectors SEC0.2, SEC0.1, SEC0.0 and three sectors SEC0. The cell C1 is for example divided into six sectors SEC1.0, SEC1.1, and four sectors SEC1. The cell C2 is for example divided into six sectors SEC2.0, SEC2.1 and four sectors SEC2. The cell C3 is for example divided into six sectors SEC3. The cell C4 is for example divided into six sectors SEC4. The cell C5 is for example divided into six sectors SEC5. The cell C6 is for example divided into six sectors SEC6.

Resource allocation in the cells C0, C1, C2, C3, C4, C5 and C6 is done per sector of the cell. In a preferred embodiment of the invention one resource allocation module is associated with each sector. In a preferred embodiment of the invention each sector is served by one transmitter and by one receiver at the base station. One sector can of course be served by more than one receiver and/or more than one transmitter or a transmitter/receiver with multiple antennas.

In a preferred embodiment of the invention layer 2 media access control instances act as resource allocation modules. Link performance data and traffic requirements are measured per terminal and per wireless link 14 at the base stations BS0, BS1, BS2, BS3, BS4, BS5 and BS6.

The network 10 can be operated in different modes of operation, characterised by the mappings of sectors incl. their transceivers, resource allocation modules and wireless resources to terminals at a given time. Different modes of operation are also characterised by the numbers of sectors and resource allocation modules serving one terminal and their interactions. Coverage and throughput are optimised by selecting appropriate modes of operation using measured link performance data per link 14 and traffic requirements per user terminal 12 and appropriate algorithms to derive the modes of operation for different mobile terminals 12 at different locations with different link qualities and different data rate requirements. Traffic requirements are for example required data rates per user terminal 12 i.e. per logical link between terminal and network comprising one or more radio links 14. Each of the base stations BS0, BS1, BS2, BS3, BS4, BS5, BS6, BS7, BS8, BS9, BS10, BS11 and BS12 shown in one of the FIGS. 1 to 6 is adapted to perform the inventive method.

Each of the base stations BS0 to BS12 has means for measuring link quality of links 14 to mobile terminals 12. Each of the base stations BS0 to BS12 has means for measuring traffic requirements per link 14. Each base station BS0 to BS12 also has means for collecting quality information for links 14 measured by neighbouring base stations for the same mobile terminal 12 and has means for collecting traffic requirements information for a mobile terminal 12 measured by the neighbouring base stations.

Each of the base stations BS0 to BS12 may have means to determine in cooperation with other base stations a master allocation module for making scheduling decisions. The master resource allocation module performs a resource allocation for a mobile terminal 12.

Each base station BS0 to BS12 is adapted to execute the resource allocation performed by the master resource allocation module. This means each base station BS0 to BS12 executes one of several modes of operation for resource allocation per terminal depending on the link qualities and traffic requirements. Each base station BS0 to BS12 is also adapted to distributing useful information to be transmitted to a mobile terminal 12 to several neighbouring base stations and is adapted to collect useful information received by neighbouring base stations from a mobile terminal 12. Each base station BS0 to BS12 is also adapted to process and to combine the useful information received from the neighbouring base stations.

In a preferred embodiment of the invention, each base station serves a sector by exactly one antenna. In another preferred embodiment of the invention each base station serves a sector by multiple antennas. In this embodiment each base station BS0 to BS12 has means to process multiple antenna signals for each wireless link 14 between the base station and the mobile terminal 12. Mixed topologies are also possible with some sectors being served by exactly one antenna and other sectors being served by multiple antennas. The one antenna—multiple antenna mixture is possible within one cell or within the network 10. It is also possible that one cell has exactly one antenna per sector and another cell has multiple antennas per sector.

The signal combination in uplink can be done in various ways. The signals sent by a mobile terminal 12 and received by different base stations BS—can for example be processed in the following ways.

According to one embodiment of the invention, the signals are transported to a common location, e.g. one of the base stations BS, before the signals are combined. The transport to the common location is for example done via the network 20, e. g. the fixed network, connecting the base stations BS. Radio Frequency (RF) signals can then be added and further processed as in the single base station case. Received RF signals can also be converted to the base band and added in the base band without further pre-processing. Another possibility is to add the base band signals with weights. The weights can for example depend on the signal strengths. The base band signals can also be pre-processed, e.g. equalized and then added. Preferably, the base band signals are added with weights and/or equalized and then added.

The pre-processing of the signals can also take place at the transmitter of the mobile terminal 12.

According to another embodiment of the invention, the strongest signal is selected upon reception, converted to the base band and transported to the common location for further processing, e. g. error correction. According to another embodiment, the received signals are converted to the base band. The baseband signals are then demodulated and/or decoded individually and the demodulated/decoded data is transported to a common location. Further processing, e. g. error correction, then takes place at the common location. Preferably, the signals are be demodulated and decoded individually and only data that can be decoded without errors is transported to the common location.

In the downlink direction from the one or more base stations over the one or more wireless links 14 the signals are preferably always added in the air. If the terminal has only one antenna, especially in the OFDM case, the sum signal can be received and processed like a conventional multi-path signal. In this case it can be advantageous to pre-process the signals at the one or more base station transmitters. The pre-processing at the one or more base stations can be done in such a way, that—depending on channel conditions—they combine coherently in the complete frequency band. Pre-processing is not necessary to achieve a performance gain but can increase the gain. If the mobile terminal 12 has more than one antenna, the components of the sum signal can be separated, e.g. according to their direction of arrival and processed similar to the uplink signals.

A preferred embodiment of the inventive method for resource allocation by selecting different modes of operation comprises the following steps. First, link quality of links 14, to and from several different mobile terminals 12 are measured via different base stations. Second, traffic requirements for the mobile terminal 12 are measured or determined in another way. Then a criterion for system performance, e.g. the average throughput per area, for different modes of operation is calculated. Areas comprise one or more parts of sectors or one or more sectors. Then a mode of operation is selected that maximises the system performance criterion. The optimisation can be done per average throughput as described above or for some other criterion or criteria.

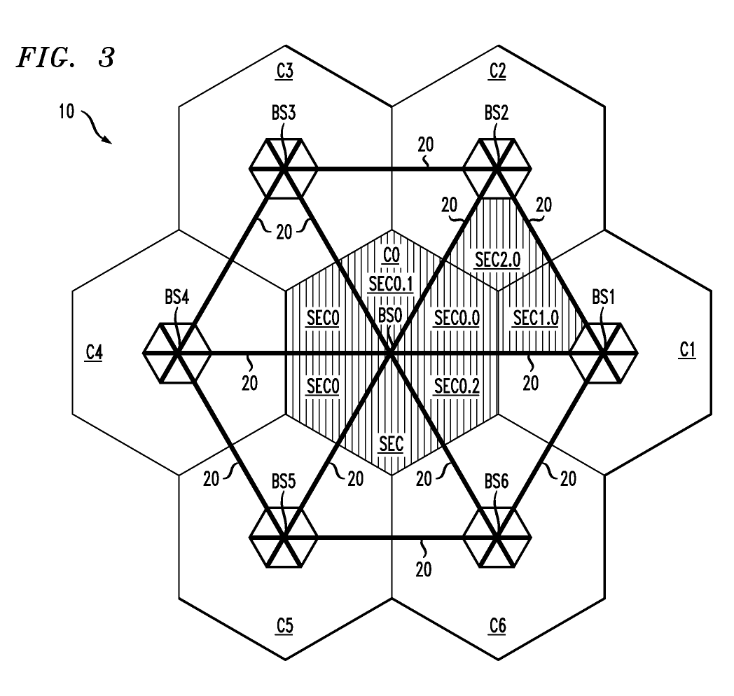

In the example shown in FIG. 3, which shows one possible mode of operation, each of the sectors of cell C0. SEC0.0 SEC0.1 SEC0.2 and three sectors SEC0, is served by base station BS0 and exactly one resource allocation module. The serving resource allocation module performing the resource allocation is in the example shown in FIG. 3 the resource allocation module associated with the sector in which the mobile terminal 12 is located. The hatched sector SEC2.0 in cell C2 is served by the resource allocation module associated with the sector SEC2.0 of base station BS2. A mobile terminal 12 being located in sector SEC1.0 of cell C1 is served by the resource allocation module associated with the sector SEC1.0 in base station BS1. In this mode of resource allocation the coverage is limited due to interference at the borders of the sectors.

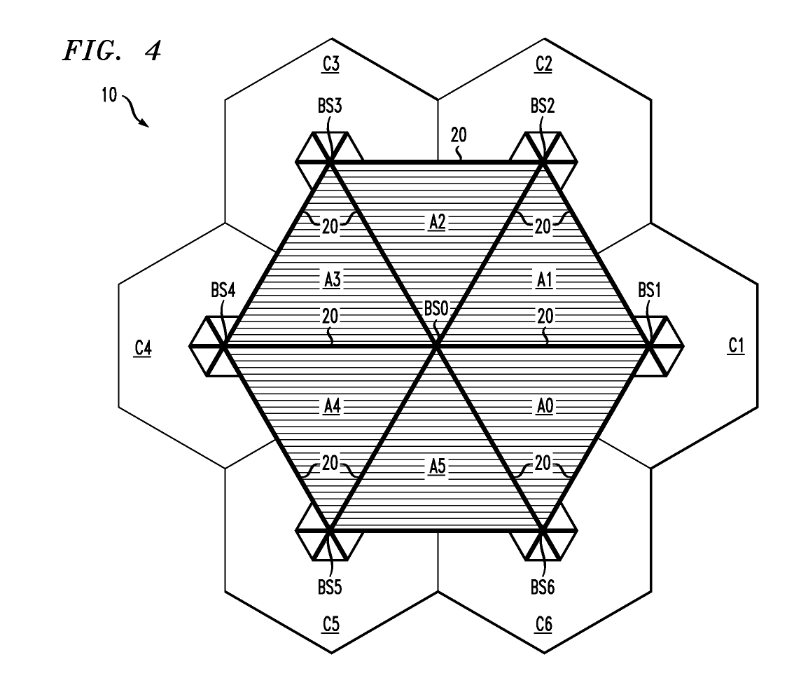

The hatched areas A0, A1, A2, A3, A4 and A5 shown in FIG. 4, which shows a second mode of operation, comprise 3 sectors. Area A0 for example comprises one sector of cell C6, one sector of cell C1 and one sector of cell C0. Area A1 for example comprises one of the original sectors of cell C2, one sector of cell C1 and one sector of cell C0. It can be seen as a new sector that is served by three base stations. It resulted from enlarging the reach of the original sectors and combining them into one. Area A2 for example comprises one sector of cell C2, one sector of cell C3 and one sector of cell C0. Three sectors with their transceivers and three resource allocation modules are involved in servicing each of these areas. For area A1 for example, this is the resource allocation module in base station BS1 which services the sector SEC1.0, the resource allocation module in base station BS2 which services the sector SEC2.0 and the resource allocation module in base station BS0 which services the sector SEC0.0. Information about and from the resource allocation modules and parts of the useful data has to be exchanged between the base stations involved in resource allocation for the hatched areas. For the downlink, radio frequency (RF) combining in the air can be used. For OFDM systems for example, the RF combining in the air can for example be done with the relative propagation delay within the cyclic prefix The sum signal can be received with one antenna and processed like a signal from only one base station, as long as the propagation delay difference is within the cyclic prefix duration. The components from different base stations look for the receiver like multi-path components due to reflections. An OFDM receiver is designed to handle such multipath signals. For other systems like e.g. CDMA synchronization may be required. For uplink, selection or base band combining of the signals received by different sectors can be applied. This can be done coherently or non-coherently.

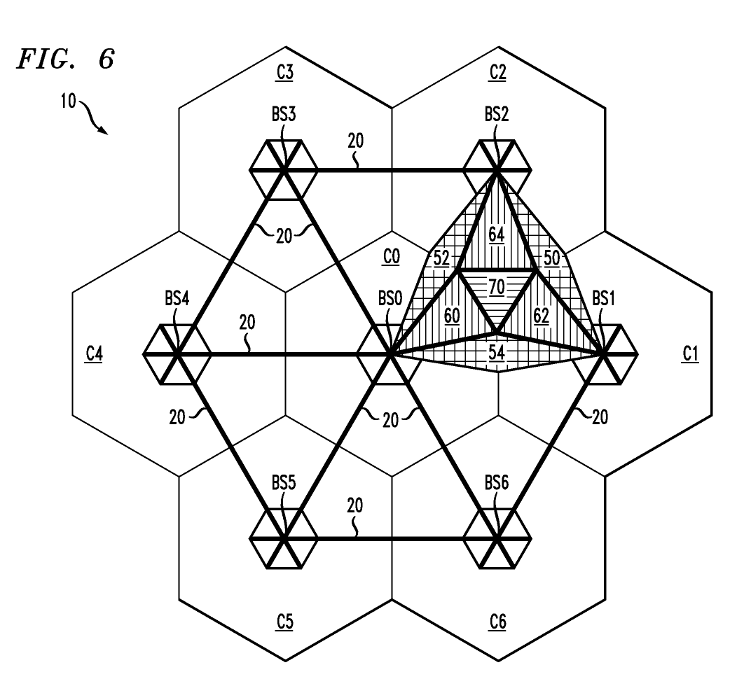

In the operation mode shown in FIG. 4 the coverage is increased compared to the operation mode in FIG. 3 by improving the signal-to-noise-and-interference ratio (SINR) at locations that are in the inner of the regions in FIG. 4 but at the borders of the regions in FIG. 3. But the throughput per area for this mode of operation may be reduced compared to the first mode of operation due to a larger area for resource allocation and the higher number of serving sectors per terminal. This is due to the fact that a master resource allocation module allocates a wireless resource, e. g. radio resource, once per area served. In the example given in FIG. 4 this means that a wireless resource, e. g. radio resource, is allocated once for three original sectors which are comprised in an area. The issue of throughput reduction when using this mode of operation in the complete cell will be addressed later with the method described in FIG. 6. There, the modes of operation are selected in such away that the overall throughput is increased.

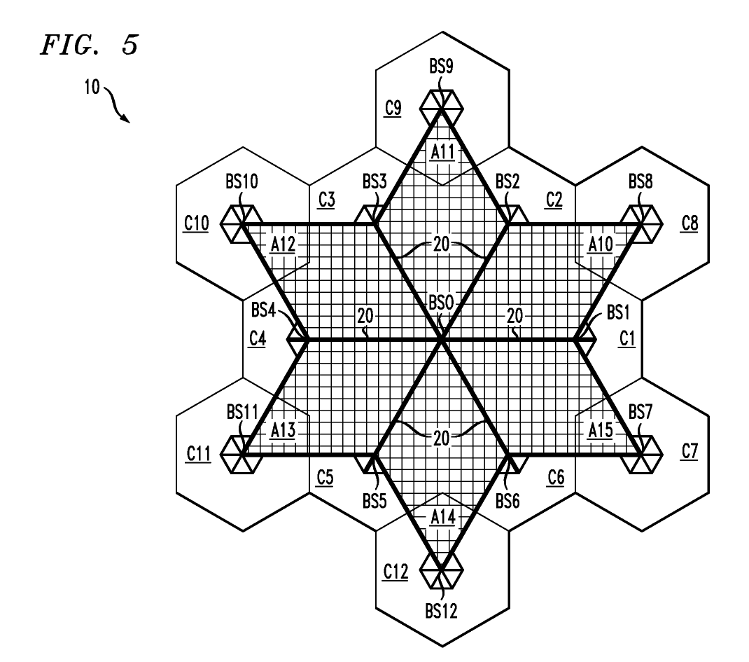

In FIG. 5, a third example of an operation mode is shown. The part of the network shown in FIG. 5 comprises thirteen cells, C0, C1, C2, C3, C4, C5, C6, C7, C8, C9, C10, C11 and C12, with their corresponding base stations, BS0, BS1, BS2, BS3, BS4, BS5, BS6, BS7, BS8, BS9, BS10, BS11 and BS12. Shown are hatched areas A10, A11, A12, A13, A14 and A15. Each area comprises six sectors of four different cells. Area A10 for example comprises one sector of cell C8, one of the sectors SEC1 of cell C1, one of the sectors SEC2 of cell C2 and sectors SEC1.0, SEC2.0 and sector SEC0.0. In between the six resource allocation modules associated with the six sectors of the area A10, one master resource allocation module is determined. The same applies to the other areas A11 to A15. A wireless resource, e. g. radio resource, is allocated once in the six sectors. This improves the SINR at further locations, but may reduce throughput per area A10, A11, A12, A13, A14 or A15. The mode of operation shown in FIG. 5 increases coverage especially for users on the direct line between two direct neighbour base stations (e.g. BS2 and BS3). To increase coverage on the direct line between BS0 and BS3 another mode of operation involving base stations BS0, BS2, BS3 and BS4 in serving one terminal can be chosen.

In FIG. 6 an example of an inter-cell coordination is shown. In the example shown, an operation mode depending on the location of the mobile terminal 12 is chosen. The location of a mobile terminal 12 within a cell is determined by measuring link quality of link 14. Link quality is preferably measured by one or more base stations. The information on link quality is exchanged in between the base stations over the links 20. Base stations BS0, BS1 and BS2 have links 20 in between them. To improve visibility those links 20 in between base stations BS0, BS1 and BS2 are not shown in FIG. 6 but they are present. They are for example shown in FIG. 1.

If a mobile terminal 12 is within the area 70 shown in FIG. 6, a mode of operation as described with reference to FIG. 4 is applied. Area 70 covers parts of the sectors SEC0.0, SEC1.0 and SEC2.0. The terminal is served by sectors SEC0.0, SEC1.0 and SEC2.0. The three resource allocation modules involved in the resource allocation are the resource allocation module associated with sector SEC0.0, the resource allocation module associated with sector SEC2.0 and the resource allocation module associated with sector SEC1.0. Those three resource allocation modules coordinate the resource allocation e.g. by determining a master resource allocation module which coordinates the resource allocation. The three resource allocation modules involved in the resource allocation, if a mobile terminal 12 is located in area 70, are located in base stations BS0, BS1 and BS2. If a mobile terminal 12 is located in one of the areas 62, 64 or 60 then a mode of operation is applied which has been described with reference to FIG. 3. If a mobile terminal 12 is located within one of the areas 60, 62 or 64 then it is served by one sector and one resource allocation module does the resource allocation for this mobile terminal. If the mobile terminal is within the area 60, then it is within the sector SEC0.0 and the resource allocation is done by the resource allocation module associated with sector SEC0.0 in base station BS0. If the mobile terminal 12 is located within the area 62, then it is within the sector SEC1.0. The resource allocation is done by the resource allocation module as associated with the sector SEC1.0. This resource allocation module is in base station BS1. If the mobile terminal 12 is located within the area 64, then the mobile terminal 12 is located within the sector SEC2.0 the resource allocation is performed by the resource allocation module associated with sector SEC2.0. This resource allocation module is in base station BS2.

Preferably, the mode of operation for a terminal is determined by the link quality measurements. The areas in FIG. 6 show regions where the link qualities are typically so that the corresponding mode of operation is appropriate. In real operation the areas may be different, for example depending on the geographic conditions.

Preferably, the selection of the mode of operation is based on long-term statistics of the channel, e.g. mean path loss, which varies only slowly with the position of the terminal and not as fast as the instantaneous channel state due to fast fading. These statistics are correlated with the position of the terminal.

If the mobile terminal 12 is located in one of the areas 50, 52 or 54 then mode of operation is applied which has been described with reference to FIG. 5. In the resource allocation for area 50 for example six sectors with their transceivers and six resource allocation modules are involved. Involved are resource allocation modules associated with one of the sectors SEC8 of cell C8 with one of the sectors SEC1 of cell C1, one of the sectors SEC2 of cell C2 and with the sectors SEC1.0, SEC2.0 and SEC0.0. Among those six resource allocation modules one master resource allocation module is determined which performs the resource allocation. The same case applies, when the mobile terminal 12 is located within area 52 or area 54.

Generally speaking, an operation mode is selected dependent on link qualities. Preferably modes are used with high average throughput per area i.e. low number of serving sectors. Where necessary, modes with higher number of serving sectors are used to increase coverage and average cell edge throughput. Depending on the link qualities and the interference situation, the wireless resource, e. g. radio resources, are allocate to one mobile terminal 12 and must be reserved in 1, 3 or 6 sectors. The base stations involved in the resource allocation exchange the information needed over the links 20. The described method increases coverage and at the same time increases average system throughput per area.

At the same time the total transmitted power per area can remain the same and the antenna sites can remain the same as well. One antenna at the mobile terminal 12 can be sufficient. This reduces cost at the mobile terminal 12.

One antenna per sector can be sufficient as well, but multiple antenna technologies can be used in addition. Multiple antenna technologies that can be applied comprise for example beam forming, multiple input multiple output techniques, including for example multiple cell/sector antennas or multiple user antennas. The use of these multiple antenna technologies can increase throughput by spatial multiplexing within the areas.

The invention offers improved coverage in the wireless communication network 10 and at the same time improved average throughput per cell. The same antenna sites as current solutions can be used. The invention can be applied to increase coverage and throughput using the same antenna sites. The total transmission power within a cell can stay the same. Wireless resources, e. g. radio resources, are better utilised and throughput is distributed more evenly among different mobile terminals 12 with different link qualities of links 14. The full set of wireless resources e. g. radio resources can be made available at all points in the wireless network area. This allows for a true frequency re-use 1 as the invention performs the interference coordination within the wireless communication network 10.

According to another aspect of the invention the links 20 in between the base stations can be used for inter cell coordination of interference. The links 20 can be used for traffic coordination in between the cells. This allows for combination of signals to and from different base stations using signal processing. A coherent combining of signals is possible. Capacity or coverage limitations can be overcome. The spatial signal to noise ratio distribution in cells can be improved.

1. Method for performing resource allocation to a mobile terminal in a wireless communication network, said wireless communication network comprising a plurality of base stations, each of said plurality of base stations serving a cell, each cell comprising a plurality of sectors; the method comprising the steps of measuring link quality of one or more wireless links in between said mobile terminal and one or more of said plurality of base stations,
allocating wireless resources to said mobile terminal in one or more serving sectors, said serving sectors being one or more of said plurality of sectors in one or more of said plurality of cells.

2. Method according to claim 1, wherein the wireless communication network being a radio communication network where the full set of radio resources can potentially be allocated at all points in the radio communication network area.

3. Method according to claim 1, wherein measuring traffic requirements of the one or more wireless links in between said mobile terminal and one or more of said plurality of base stations.

4. Method according to claim 1, wherein performing signal processing on the signals received at one or more of said plurality of base stations from the mobile terminal over the one or more wireless links.

5. Method according to claim 1, wherein performing signal processing on the signals received at the mobile terminal over the one or more wireless links from the one or more of said plurality of base stations.

6. Method according to claim 1, whereas each cell comprises a plurality of resource allocation modules, each of said plurality of resource allocation modules being associated with at least one of said plurality of sectors, and whereas the resource allocation is performed by the one or more resource allocation modules associated with said one or more serving sectors.

7. Method according to claim 6, further comprising the step of determining a master resource allocation module among the one or more resource allocation modules associated with said one or more serving sectors, said master resource allocation module performing the resource allocation in coordination with other involved resource allocation modules to said mobile terminal in said serving sectors.

8. Method according to claim 7, wherein the determination of the master resource allocation module being performed by the resource allocation modules associated with the one or more serving sectors.

9. Method according to claim 6, wherein each of said resource allocation modules being a Media Access Control instance.

10. A plurality of base stations of a wireless communication network, each of said plurality of base stations serving a cell, each cell comprising a plurality of sectors, whereas
each of said plurality of base stations is adapted to measure link quality of one or more wireless links to a mobile terminal and comprises means for determining one or more serving sectors, said serving sectors being one or more of said plurality of sectors in one or more of said plurality of cells, whereas resource allocation to the mobile terminal is performed in the one or more serving sectors.

11. A plurality of base stations according to claim 10, wherein said plurality of base stations being base stations of a radio communication network where the full set of radio resources can potentially be allocated at all points in the radio communication network area.

12. A plurality of base stations according to claim 10, wherein each of said plurality of base stations being adapted to measure traffic requirements of the one or more wireless links to said mobile terminal.

13. A plurality of base stations according to claim 10, wherein means for performing signal processing on the signals received from the mobile terminal over the one or more wireless links.

14. A plurality of base stations according to claim 10, wherein performing signal pre-processing on the signals transmitted to the mobile terminal over the one or more wireless links.

15. A plurality of base stations according to claim 10, wherein each cell comprising a plurality of resource allocation modules, each of said plurality of resource allocation modules being associated with at least one of said plurality of sectors, whereas the resource allocation is performed by the one or more resource allocation modules associated with said one or more serving sectors.

16. A plurality of base stations according to claim 15, further wherein
means for determining a master resource allocation module among the one or more resource allocation modules associated with said one or more serving sectors, said master resource allocation module performing the resource allocation to said mobile terminal in the one or more serving sectors.

17. A plurality of base stations according to claim 16, wherein the determination of the master resource allocation module being performed by the resource allocation modules associated with the one or more serving sectors.

18. A plurality of base stations according to claim 15, wherein each of said resource allocation modules being a Media Access Control instance.

19. A plurality of base stations according to claim 10 in a wireless communication network.

20. A plurality of base stations according to claim 19, wherein
said wireless communication network being a radio network where the full set of radio resources can potentially be allocated at all points in the wireless network area.
